(19) United States
(12) Patent Application Publication
(10) Pub. No.: US 2012/0026526 A1
(43) Pub. Date: Feb. 2, 2012

(54) IMAGE PROCESSING SYSTEM THAT CAUSES PC TO DISPLAY PREVIEW IMAGE, METHOD OF CONTROLLING THE SAME, AND STORAGE MEDIUM

(75) Inventor: Hiroshi SEKINE, Kawasaki-shi (JP)

(73) Assignee: CANON KABUSHIKI KAISHA, Tokyo (JP)

(21) Appl. No.: 13/196,424

(22) Filed: Aug. 2, 2011

(30) Foreign Application Priority Data
Aug. 2, 2010 (JP) 2010-173624(PAT.)

(51) Int. Cl. G06K 15/02

(52) U.S. Cl. 358/1.13

(57) ABSTRACT

An image processing system which makes it possible to confirm a processing result in advance even when an image processing apparatus is not equipped with a display unit that can display a preview image. The image processing system includes a multifunction printer, a server, and a PC, which are interconnected via a network in a manner capable of communicating with each other. The server acquires an image read by the multifunction printer, and generates a preview image which represents an image subjected to image processing. The multifunction printer transmits UI screen information including a link to a URL of the preview image generated by the server to the PC in response to an access from the PC. The PC acquires the preview image stored in the server based on the UI screen information received from the multifunction printer, and displays the preview image.

### BACKGROUND OF THE INVENTION

1. Field of the Invention

The present invention relates to an image processing system in which when an image processing apparatus performs copying, the image processing apparatus causes a first external apparatus to create a preview image which represents a result of the copying, and causes a display unit of a second external apparatus to display the preview image, a method of controlling the image processing system, and a storage medium.

2. Description of the Related Art

A multifunction printer has a plurality of print functions which can be executed by the multifunction printer alone. Examples of these print functions include an N-in-1 copy function that collectively prints a plurality of original images on one sheet, an insert function that inserts an insert sheet between specified pages and performs printing, and a combining function that combines an original image and a specified image, and prints the combined image.

Further, to realize a print function which is not supported by a multifunction printer, there has been proposed a printing system using a server installed on a network, for performing image processing corresponding to the print function, on behalf of the multifunction printer (see e.g. Japanese Patent Laid-Open Publication No. 2003-288336). For example, in a case where a multifunction printer does not support the N-in-1 copy function, when a user instructs e.g. “2-in-1 copy” from a console panel of the multifunction printer, the multifunction printer transmits a “2-in-1 copy” request and image data of the input original to the server. The server generates image data formed by collecting two images on one sheet in response to the request, and transmits the generated image data to the multifunction printer. The multifunction printer receives the image data transmitted from the server, and performs printing of the image data.

In this printing system, the server on the network supports a lot of print functions on behalf of multifunction printers, which makes it unnecessary for the multifunction printers to support the print functions. As a result, it is possible to reduce the costs of the multifunction printers.

In the above-described printing system, when using a multifunction printer equipped with a display device that displays a preview image representing a result of image processing by the server, i.e. an image to be printed, it is possible to confirm the printing result in the multifunction printer before printing. When using a multifunction printer which is not equipped with a display device that can display a preview image, however, the user cannot confirm a printing result before printing. Therefore, in the above-described printing system, for a user to confirm a printing result on a multifunction printer before printing, it is necessary to use a multifunction printer including a display unit that can display a preview image, and this limits usable multifunction printers.

### SUMMARY OF THE INVENTION

The present invention provides an image processing system which makes it possible to confirm a processing result in advance even when an image processing apparatus is not equipped with a display unit that can display a preview image, a method of controlling the image processing system, and a storage medium.

In a first aspect of the present invention, there is provided an image processing system including an image processing apparatus having a function of reading an original and printing an image obtained by the reading, a first external apparatus including an image processing unit, and a second external apparatus including a display unit, wherein the image processing apparatus, the first external apparatus, and the second external apparatus are connected to each other via a network in a manner capable of communicating with each other, wherein the first external apparatus comprises an image acquisition unit configured to acquire the image read by the image processing apparatus, and a generation unit configured to generate a preview image which represents an image formed by subjecting the image acquired by the image acquisition unit to image processing by the image processing unit, wherein the image processing apparatus comprises a transmission unit configured to transmit storage location information indicative of a location where the preview image generated by the first external apparatus is stored to the second external apparatus, in response to an access from the second external apparatus, and wherein the second external apparatus comprises an acquisition unit configured to acquire the preview image stored in the first external apparatus, based on the storage location information received from the image processing apparatus, and a display unit configured to display the preview image acquired by the acquisition unit.

In a second aspect of the present invention, there is provided a method of controlling an image processing system including an image processing apparatus having a function of reading an original and printing an image obtained by the reading, a first external apparatus including an image processing unit, and a second external apparatus including a display unit, wherein the image processing apparatus, the first external apparatus, and the second external apparatus are connected to each other via a network in a manner capable of communicating with each other, wherein the first external apparatus acquires an image read by the image processing apparatus, and generates a preview image which represents an image formed by subjecting the acquired image to image processing by the image processing unit, wherein the image processing apparatus transmits storage location information indicative of a location where a preview image generated by the first external apparatus is stored to the second external apparatus, in response to an access from the second external apparatus, and wherein the second external apparatus acquires the preview image stored in the first external apparatus, based on the storage location information received from the image processing apparatus, and displays the acquired preview image.

In a third aspect of the present invention, there is provided an image processing apparatus that is capable of communicating with a first external apparatus including an image processing unit, and a second external apparatus including a display unit, comprising a reading unit configured to read an original to generate an image, a first transmission unit configured to transmit the image generated by the reading unit to the first external apparatus, a reception unit configured to receive storage location information indicative of a location where a preview image is stored which represents an image formed by subjecting the image transmitted by the first transmission unit to image processing by the first external apparatus, from the first external apparatus, a second transmission unit configured to transmit the storage location information to the second external apparatus in response to an access from the second external apparatus, and a printing unit configured to execute printing based on the image transmitted from the first external apparatus in response to a print instruction from the second external apparatus.

In a fourth aspect of the present invention, there is provided a method of controlling an image processing apparatus that is capable of communicating with a first external apparatus including an image processing unit, and a second external apparatus including a display unit, comprising reading an original to generate an image, transmitting the generated image to the first external apparatus, receiving storage location information indicative of a location where a preview image is stored which represents an image formed by subjecting the transmitted image to image processing by the first external apparatus, from the first external apparatus, transmitting the storage location information to the second external apparatus in response to an access from the second external apparatus, and executing printing based on the image transmitted from the first external apparatus in response to a print instruction from the second external apparatus.

In a fifth aspect of the present invention, there is provided a computer-readable storage medium storing a computer-executable program causing a computer to execute a method of controlling an image processing apparatus that is capable of communicating with a first external apparatus including an image processing unit, and a second external apparatus including a display unit, wherein the method comprises reading an original to generate an image, transmitting the generated image to the first external apparatus, receiving storage location information indicative of a location where a preview image is stored which represents an image formed by subjecting the transmitted image to image processing by the first external apparatus, from the first external apparatus, transmitting the storage location information to the second external apparatus in response to an access from the second external apparatus, and executing printing based on the image transmitted from the first external apparatus in response to a print instruction from the second external apparatus.

According to the present invention, even when an image processing apparatus is not equipped with a display unit that can display a preview image, it is possible to confirm a processing result in advance.

The features and advantages of the invention will become more apparent from the following detailed description taken in conjunction with the accompanying drawings.

### BRIEF DESCRIPTION OF THE DRAWINGS

FIG. 1 is a schematic diagram of an image processing system according to a first embodiment of the present invention.

FIG. 2 is a block diagram of a multifunction printer appearing in FIG. 1.

FIG. 3 is a block diagram of a PC appearing in FIG. 1.

FIG. 4 is a block diagram of a server appearing in FIG. 1.

FIG. 5 is a flowchart of a process executed by the multifunction printer when copying is performed by the multifunction printer in the image processing system shown in FIG. 1.

FIG. 6 is a flowchart of a process executed by the server when copying is performed by the multifunction printer in the image processing system shown in FIG. 1.

FIG. 7 is a flowchart of a process executed by the PC when copying is performed by the multifunction printer in the image processing system shown in FIG. 1.

FIG. 8 illustrates an example of screen information including a link to a URL of a preview image.

FIG. 9 illustrates an example of a preview image-displaying screen.

FIGS. 10A AND 10B are a flowchart of a process executed by the multifunction printer when copying is performed by the multifunction printer in an image processing system according to a second embodiment of the present invention.

FIGS. 11A and 11B are a flowchart of a process executed by the server when copying is performed by the multifunction printer in the image processing system according to the second embodiment.

### DESCRIPTION OF THE EMBODIMENTS

The present invention will now be described in detail below with reference to the accompanying drawings showing embodiments thereof.

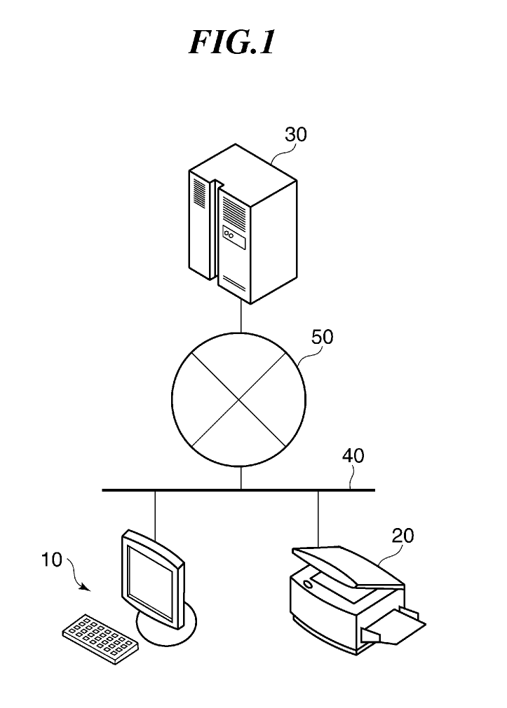

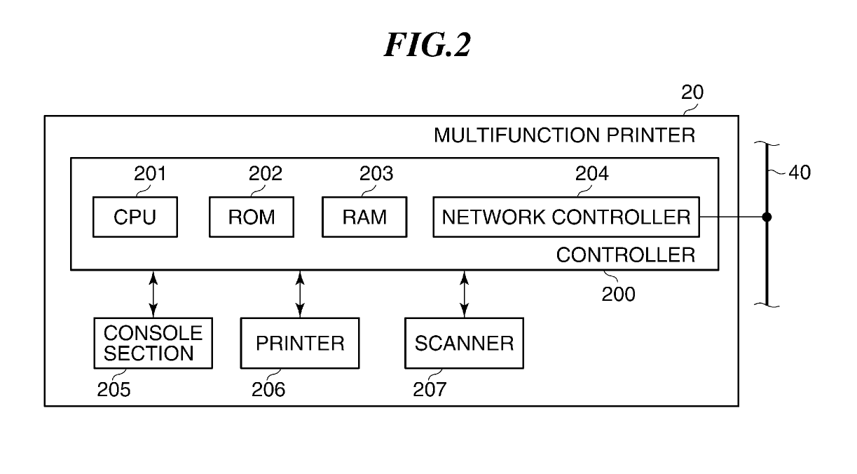

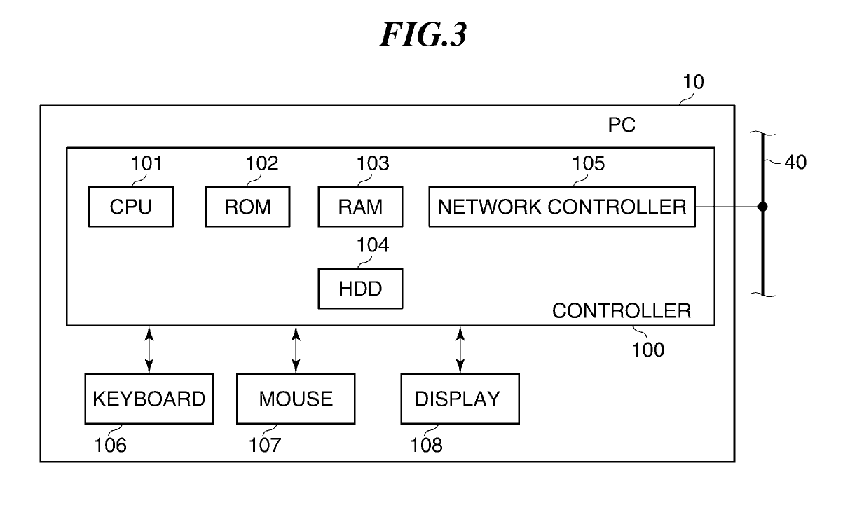

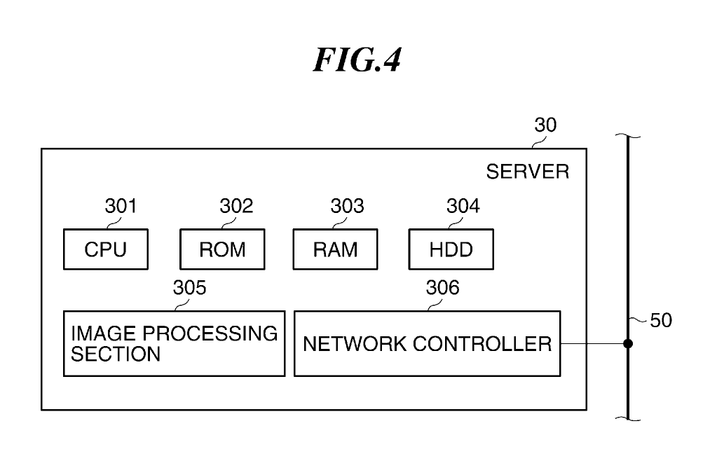

FIG. 1 is a schematic diagram of an image processing system according to a first embodiment of the present invention. FIG. 2 is a block diagram of a multifunction printer 20 appearing in FIG. 1. FIG. 3 is a block diagram of a PC 10 appearing in FIG. 1. FIG. 4 is a block diagram of a server 30 appearing in FIG. 1.

As shown in FIG. 1, the image processing system according to the present embodiment includes the multifunction printer 20, the PC 10, and the server 30. The multifunction printer 20, the PC 10, and the server 30 are interconnected via a network implemented by the Internet 50 and a LAN (local area network) 40 in a manner capable of communicating with each other.

The multifunction printer 20 has a plurality of functions, such as a copy function and a print function, and is connected to the LAN 40. The PC 10 has a display (display unit) 108, referred to hereinafter, and is connected to the LAN 40. The server 30 is connected to the Internet 50.

As shown in FIG. 2, the multifunction printer 20 includes a controller 200 including a CPU 201, a ROM 202, a RAM 203, and a network controller 204. Connected to the controller 200 are a console section 205, a printer 206 which performs printing, and a scanner 207 which reads an image from an original.

The CPU 201 performs processing and control according to instructions input by a user from the console section 205 and instructions received by the network controller 204, according to programs stored in the ROM 202. This control includes control of the printer 206 and the scanner 207. The RAM 203 provides a work area for the CPU 201, and an area for temporarily storing various items of data, such as print data.

The network controller 204 is connected to the LAN 40, and performs transmitting and receiving data to and from the PC 10 via the LAN 40, and transmitting and receiving data to and from the server 30 via the LAN 40 and the Internet 50.

The console section 205 includes a plurality of keys (not shown) and a liquid crystal display panel (not shown). The liquid crystal display panel displays a user interface (UI) screen via which the user configures various kinds of settings, such as setting of an operation mode, and contents of the settings. However, the liquid crystal display panel is not configured to have a screen having a resolution high enough and a size large enough to display a preview image of an image to be printed.

The multifunction printer 20 has a remote user interface function (remote UI function) for enabling a Web server of the multifunction printer 20 to be accessed from a Web browser of the PC 10 for configuration of settings of the multifunction printer 20 and confirmation of the details of the settings.

As shown in FIG. 3, the PC 10 includes a controller 100 including a CPU 101, a ROM 102, a RAM 103, an HDD 104, and a network controller 105. Connected to the controller 100 are a keyboard 106, a mouse 107, and the display 108.

The CPU 101 starts up an OS (operating system) stored in the HDD 104 based on a boot program stored in the ROM 102. Then, the CPU 101 performs processing according to instructions input by the user from the keyboard 106 and the mouse 107, and instructions received by the network controller 105, and performs control for displaying a result of the processing on the display 108. The RAM 103 provides a work area for the CPU 101, and an area for temporarily storing various items of data.

The network controller 105 is connected to the LAN 40, for transmitting and receiving data to and from the multifunction printer 20 via the LAN 40, and transmitting and receiving data to and from the server 30 via the LAN 40 and the Internet 50.

As shown in FIG. 4, the server 30 includes a CPU 301, a ROM 302, a RAM 303, an HDD 304, an image processing section 305, and a network controller 306. The CPU 301 starts up an OS (operating system) stored in the HDD 304 based on a boot program stored in the ROM 302. Then, the CPU 301 performs processing according to instructions received by the network controller 306 and so forth. The RAM 303 provides a work area for the CPU 301, and an area for temporarily storing various items of data.

The image processing section 305 performs various kinds of image processing, such as combining of two images, and generates a preview image representing an image to be formed by printing the image subjected to the image processing. The preview image is stored in the HDD 304.

The network controller 306 is connected to the Internet 50, for transmitting and receiving data to and from the multifunction printer 20 and the PC 10 via the Internet 50 and the LAN 40.

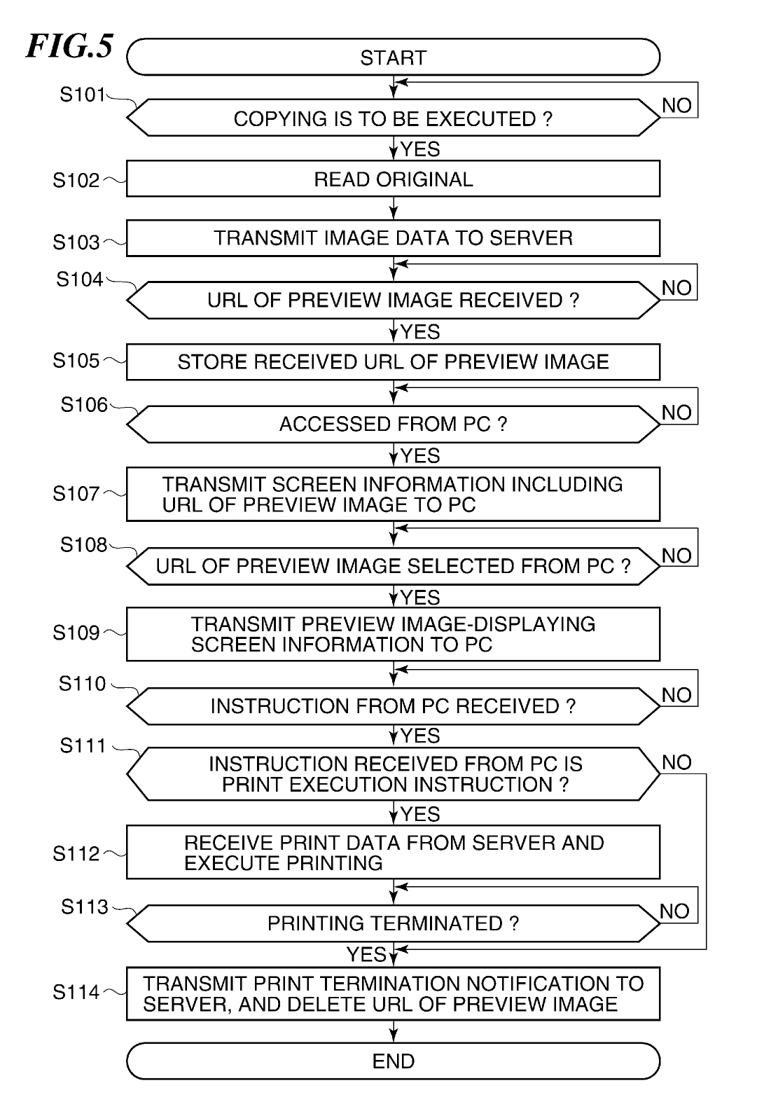

In the present embodiment, when an original is copied by the multifunction printer 20, processing is performed for displaying a preview image which represents a printing result (copying result) on the display 108 of the PC 10 before printing the image read from the original by the printer 206. A description will be given of this processing with reference to FIGS. 5 to 9.

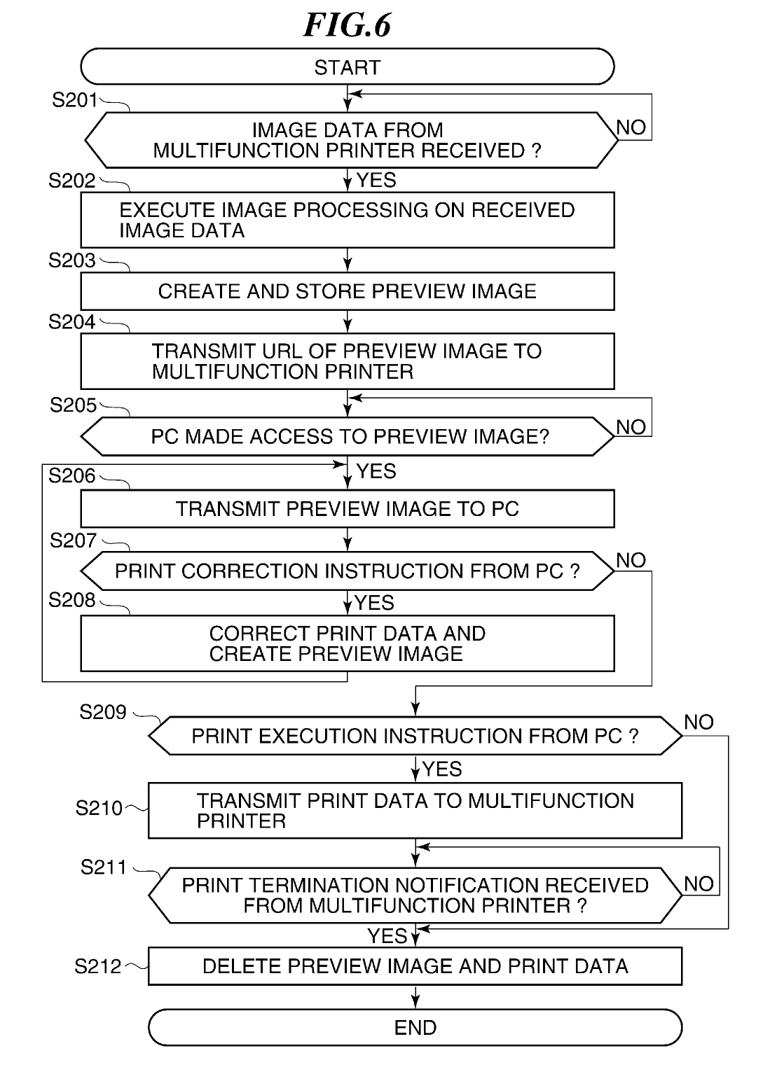

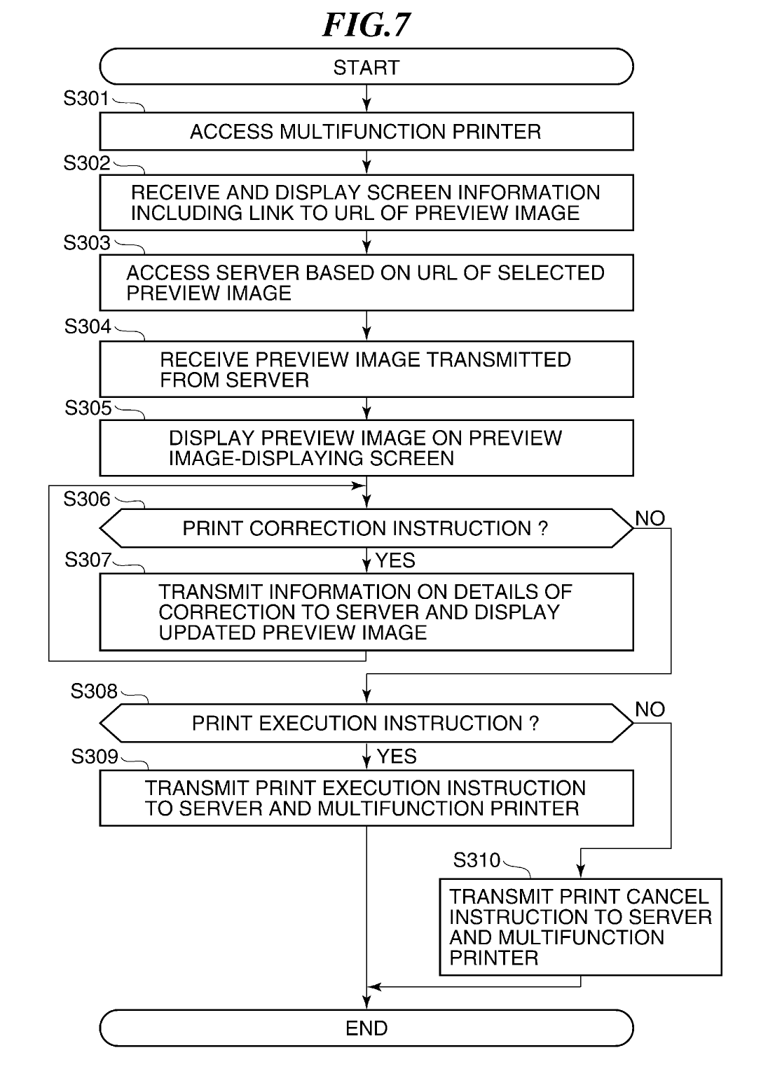

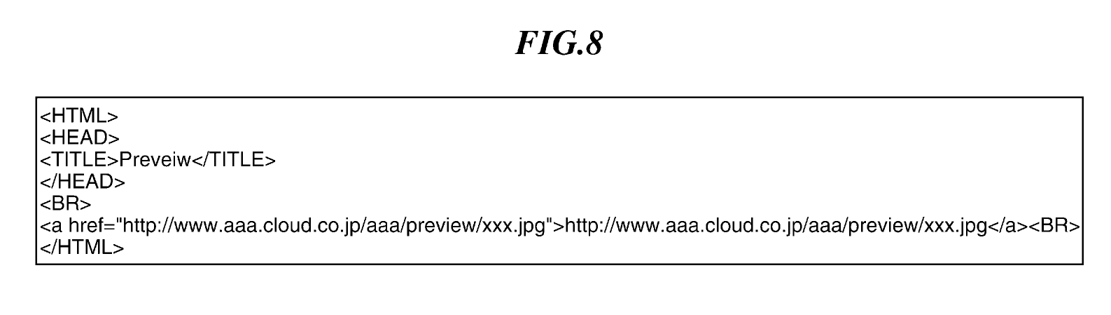

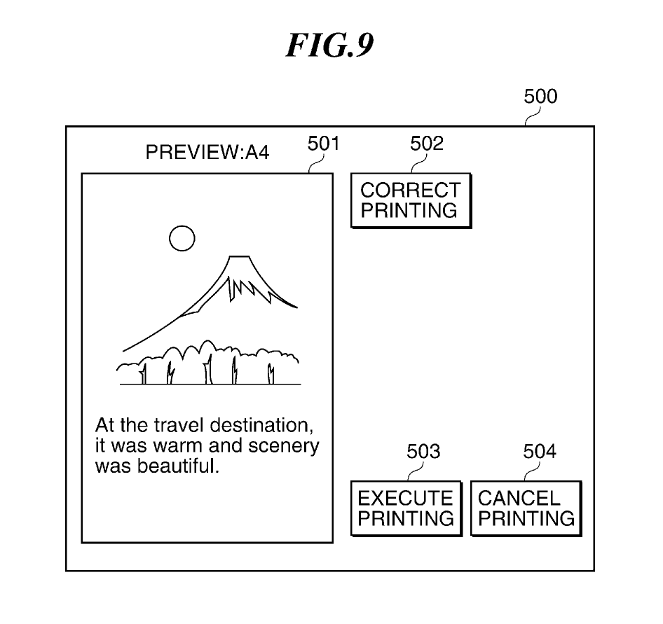

FIG. 5 is a flowchart of a process executed by the multifunction printer 20 when copying is performed by the multifunction printer 20 in the image processing system shown in FIG. 1. FIG. 6 is a flowchart of a process executed by the server 30 when copying is performed by the multifunction printer 20 in the image processing system shown in FIG. 1. FIG. 7 is a flowchart of a process executed by the PC 10 when copying is performed by the multifunction printer 20 in the image processing system shown in FIG. 1. FIG. 8 illustrates an example of screen information including a link to a URL of a preview image. FIG. 9 illustrates an example of a preview image-displaying screen.

When copying an original by the multifunction printer 20, the user sets the original on the scanner 207. Then, the user instructs execution of copying by depressing an associated key of the console section 205.

As shown in FIG. 5, upon reception of the instruction of execution of copying input by the user from the console section 205 (step S101), the CPU 201 controls the multifunction printer 20 to read the original by the scanner 207 (step S102). Then, the CPU 201 controls the multifunction printer 20 to transmit the image data read by the scanner 207 to the server 30 via the network controller 204 (step S103).

Next, the CPU 201 waits for the network controller 204 to receive an URL (storage location information) indicative of a location in the server 30 where the preview image created thereby based on the image data is stored (step S104). Then, upon reception of the URL of the preview image, the CPU 201 stores the received URL of the preview image in the RAM 203 (step S105).

Then, upon reception of an access from the PC 10 (step S106), the CPU 201 creates user interface screen information (UI screen information) including a link to the URL of the preview image (step S107). The UI screen information is transmitted to the PC 10 via the network controller 204. Note that the UI screen information is information configuring a screen which provides a link to the URL and enables an operation of selecting the URL of the preview image to be received as an operation of accessing the preview image. The UI screen information is described using a predetermined language, e.g. HTML, and is described e.g. as shown in FIG. 8. The PC 10 displays the user interface screen (UI screen) on the display 108, which can receive the operation of selecting the URL of the preview image by the user who operates the PC 10, based on the UI screen information, as described hereinafter.

Next, the CPU 201 waits for reception of operation information indicating that the URL of the preview image has been selected by the user who operates the PC 10 via the UI screen displayed on the display 108 thereof (step S108). Then, upon reception of the operation information, the CPU 201 creates information on the preview image-displaying screen (preview image-displaying screen information) via the network controller 204, and controls the multifunction printer 20 to transmit the created information to the PC 10 via the network controller 204 (step S109). Note that the preview image-displaying screen information is information configuring the preview image-displaying screen denoted by reference numeral 500 as shown in FIG. 9, which includes a print correction button 502, a print execution button 503, and a print cancel button 504, but does not include a preview image 501. The preview image-displaying screen information is described using a predetermined language, e.g. HTML. Further, the preview image 501 is pasted in a predetermined area on the preview image-displaying screen 500 by processing performed by the PC 10, as described hereinafter.

Next, the CPU 201 waits for reception of instruction information indicative of an instruction selected by the user's operation on the preview image-displaying screen configured by the preview image-displaying screen information on the display 108 of the PC 10 (step S110). At this time, as shown in FIG. 9, the preview image-displaying screen has the preview image 501 pasted thereon which is acquired by the PC 10 from the server 30. Further, the instruction indicated by the instruction information received by the multifunction printer 20 is one of a print execution instruction (given by the print execution button 503) and a print cancel instruction (given by the print cancel button 504), as described hereinafter.

Next, upon reception of the instruction information, the CPU 201 determines whether or not the instruction information indicates the print execution instruction (step S111). If it is determined that the instruction information indicates the print execution instruction, the CPU 201 receives print data transmitted from the server 30 via the network controller 204, and causes the printer 206 to execute printing of the print data(step S112).

Next, when the printing is terminated (step S113), the CPU 201 sends a print termination notification to the server 30 via the network controller 204, and causes the URL of the preview image to be deleted from the RAM 203 (step S114). Then, the CPU 201 terminates the present process.

If it is determined in the step S111 that the instruction information does not indicate the print execution instruction, it means that the instruction information indicates the print cancel instruction. In this case, the CPU 201 skips over the steps S112 and S113 to the step S114. Then, the CPU 201 terminates the present process.

In the server 30, as shown in FIG. 6, the CPU 301 waits for reception of the image data transmitted from the multifunction printer 20 via the network controller 306 (step S201). Then, upon reception of the image data from the multifunction printer 20, the CPU 301 causes image processing to be performed on the received image data to thereby generate print data (step S202). The generated print data is stored in the HDD 304.

Next, the CPU 301 generates a preview image which indicates a copied image (image to be formed by printing the print data), and stores the preview image in the HDD 304 (step S203). Then, the CPU 301 causes the URL indicative of the area of the HDD 304 where the preview image is stored to be transmitted to the multifunction printer 20 via the network controller 306 (step S204).

Then, the CPU 301 waits for an operation of accessing the preview image to be performed by the user selecting the URL of the preview image at the PC 10 (step S205). Then, when the operation of accessing the preview image is performed at the PC 10, the CPU 301 transmits the preview image stored in the HDD 304 to the PC 10 via the network controller 306 (step S206).

Next, the CPU 301 determines whether or not the instruction information from the PC 10 received via the network controller 306 indicates a print correction instruction (given by the print correction button 502 in FIG. 9) (step S207). If it is determined that the instruction information indicates the print correction instruction, the CPU 301 causes the image processing section 305 to correct the print data according to the print correction instruction (step S208). The correction of the print data is performed according to a well-known method and procedure, and hence description thereof is omitted. Further, the CPU 301 causes the image processing section 305 to create a preview image which represents an image to be formed by printing the corrected print data. The corrected print data and the preview image are stored in the HDD 304. Then, the CPU 301 returns to the step S206.

If it is determined in the step S207 that the instruction information does not indicate a print correction instruction, the CPU 301 determines whether or not the instruction information indicates a print execution instruction (step S209). If it is determined that the instruction information indicates a print execution instruction, the CPU 301 causes the print data to be transmitted to the multifunction printer 20 via the network controller 306 (step S210).

Next, the CPU 301 waits for reception of the print termination notification from the multifunction printer 20 (step S211), and upon reception of the print termination notification, the CPU 301 causes the preview image and print data stored in the HDD 304 to be deleted (step S212). Then, the CPU 301 terminates the present process.

If it is determined in the step S209 that the instruction information does not indicate a print execution instruction, it means that the instruction information indicates the print cancel instruction. In this case, the CPU 301 skips over the steps S210 and 211 to the step S212. Then, the CPU 301 terminates the present process.

When scanning the original by the multifunction printer 20 is terminated, the user moves to the PC 10 e.g. after picking up the original, and operates the PC 10 to confirm the preview image representing the image to be formed by printing the image scanned from the original is copied.

In the PC 10, as shown in FIG. 7, the CPU 101 controls the PC 10 to access the multifunction printer 20 using the remote UI function of the multifunction printer 20 (step S301). In this step, in the PC 10, the user starts up the Web browser, and inputs e.g. an IP address of the multifunction printer 20. This causes the PC 10 to access the multifunction printer 20, and the remote UI is started up by the multifunction printer 20.

Then, the CPU 101 receives the screen information (screen information including the link to the URL of the preview image) from the multifunction printer 20 via the network controller 105, and causes the screen configured by the screen information to be displayed on the display 108 (step S302). Then, the CPU 101 controls the PC 10 to access the preview image stored in the server 30 based on the URL of the preview image selected by the user on the screen displayed on the display 108 (step S303).

Then, the CPU 101 receives the preview image transmitted from the server 30 in response to the above access, via the network controller 105 (step S304). Then, the CPU 101 receives the preview image-displaying screen information from the multifunction printer 20 via the network controller 105, and causes the preview image-displaying screen (denoted by reference numeral 500 in FIG. 9) to be displayed on the display 108 (step S305). At this time, as shown in FIG. 9, the received preview image 501 is pasted and displayed on the preview image-displaying screen 500. The user confirms the preview image 501 on the preview image-displaying screen 500, and selects one of the print correction instruction, the print execution instruction, and the print cancel instruction, by depressing an associated one of the print correction button 502, the print execution button 503, and the print cancel button 504.

Next, the CPU 101 determines whether or not the user has selected the print correction instruction (the print correction button 502) (step S306). In this step, if it is determined that the print correction instruction has been selected, the CPU 101 causes information on details of the correction to be transmitted to the server 30 via the network controller 105 (step S307). Further, the CPU 101 receives a preview image of the print data corrected by the server 30 via the network controller 105, and controls the PC 10 to display the preview image. Then, the CPU 101 returns to the step 306.

If it is determined in the step S306 that the print correction instruction has not been selected, the CPU 101 determines whether or not the user has selected the print execution instruction (the print execution button 503) (step S308). In this step, if it is determined that the print execution instruction (the print execution button 503) has been selected, the CPU 101 controls the PC 10 to transmit instruction information indicative of the print execution instruction to the server 30 and the multifunction printer 20 via the network controller 105 (step S309). Then, the CPU 101 terminates the present process.

If it is determined in the step S308 that the print execution instruction has not been selected, it means that the print cancel instruction has been selected. In this case, the CPU 101 controls the PC 10 to transmit instruction information indicative of the print cancel instruction to the server 30 and the multifunction printer 20 via the network controller 105 (step S310). Then, the CPU 101 terminates the present process.

As described above, even when the multifunction printer 20 is not equipped with a display device having a resolution high enough to display a preview image of an image to be formed when printed, it is possible to display the preview image on the display 108 of the PC 10. This enables the user to confirm the image to be printed before printing, and hence it is possible to prevent consumable materials, such as ink or toner, from being wasted due to printing of an image different from one intended by the user.

Although in the present embodiment, an URL is used as information indicative of a location where a preview image is stored, known location information, such as a unique numerical value, can be used in place thereof.

Further, in the present embodiment, the multifunction printer 20 creates preview image-displaying screen information, and the server 30 creates a preview image. Instead of this, the server 30 may create preview image-displaying screen information and a preview image, and transmit both of them to the PC 10. In this case, the server 30 may transmit preview image-displaying screen information in timing in which the server 30 transmits the preview image to the PC 10.

Further, in the present embodiment, the multifunction printer 20 creates screen information including a link to a URL of a preview image. Instead of this, the server 30 may create screen information including a link to a URL of a preview image, and transmit the created screen information to the multifunction printer 20, and then the multifunction printer 20 may receive and store the UI screen information. This makes it possible to reduce load of processing for creating the UI screen information on the multifunction printer 20.

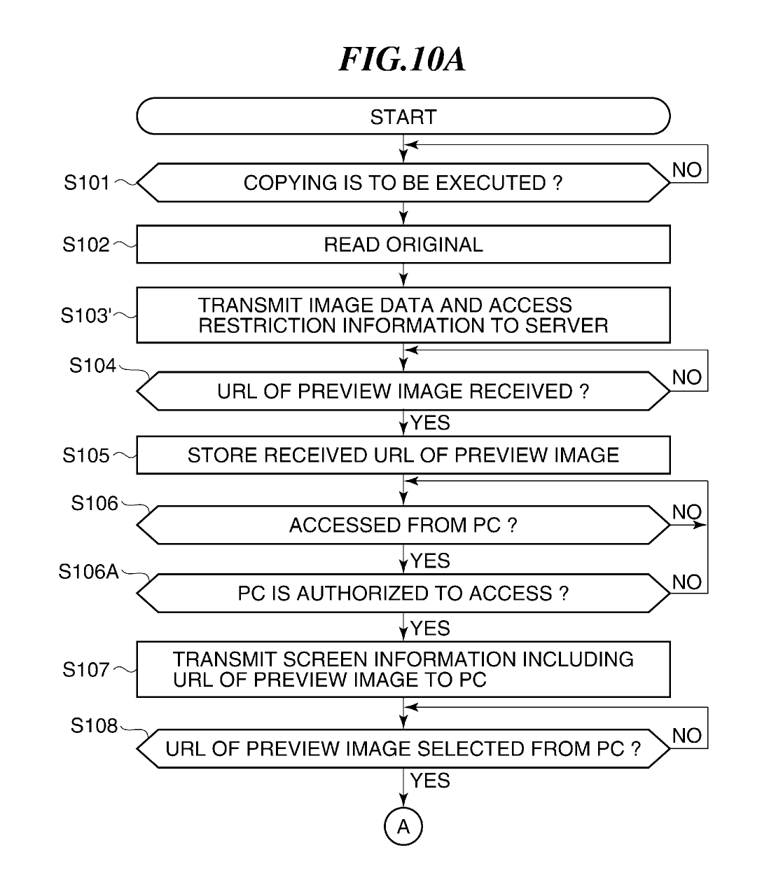

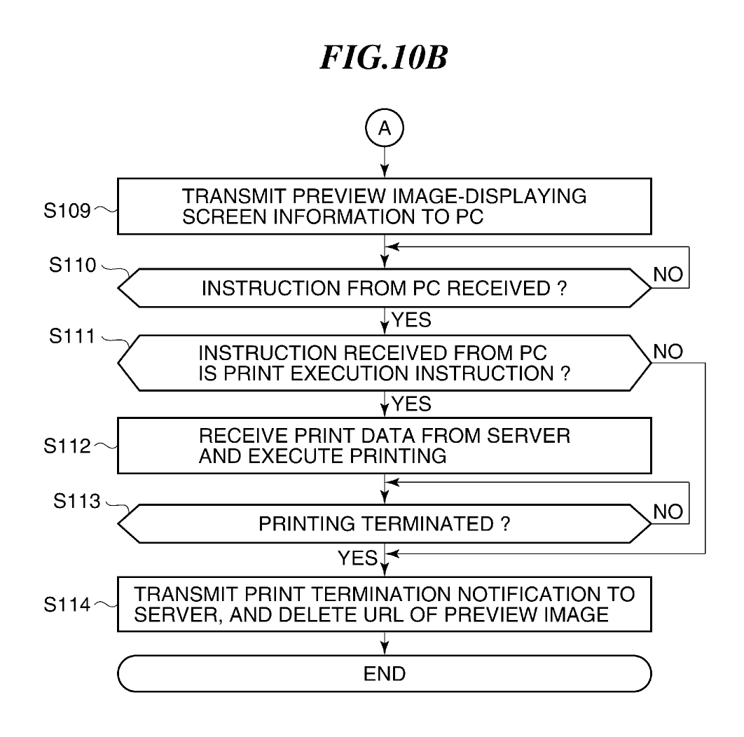

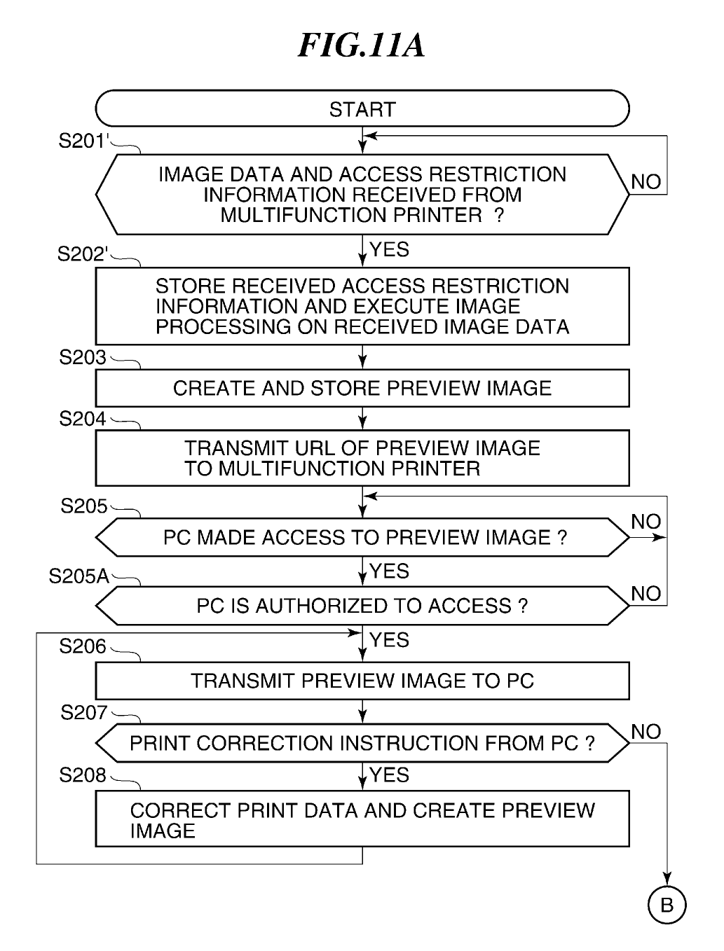

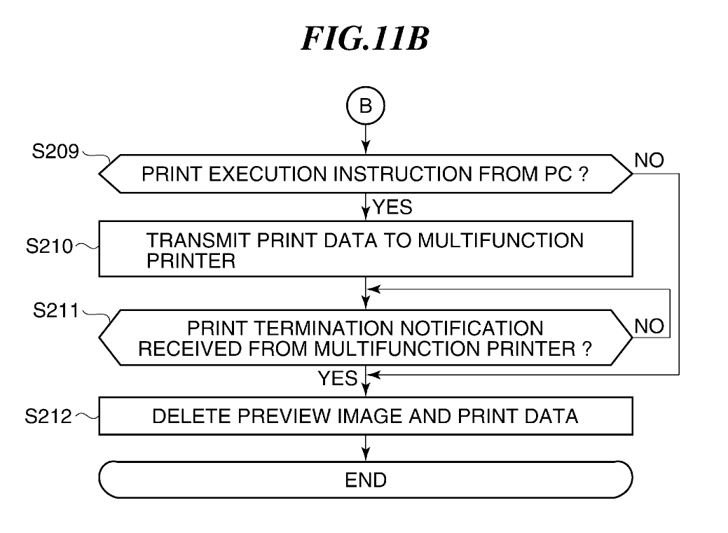

Next, a description will be given of a second embodiment of the present invention with reference to FIGS. 10 and 11. The present embodiment has the same configuration as that of the first embodiment except that processes in FIGS. 10A and 10B and 11A and 11B are slightly different from the corresponding processes of the first embodiment, and hence in the following description, component elements identical to corresponding ones of the first embodiment are denoted by the same reference numerals.

Normally, a plurality of PCs including the PC 10 are connected to the LAN 40, and if other PCs different from the PC 10 are configured to be capable of accessing the remote UI of the multifunction printer 20, a preview image stored in the server 30 can be viewed from the other PCs. This is undesirable from the viewpoint of security.

To solve this problem, in the present embodiment, accesses from the other PCs to the preview image are restricted so as to prevent the preview image which is stored in the server 30 when the user of the PC 10 copies an original using the multifunction printer 20 from being viewed from the other PCs.

This access restriction is performed as follows:

First, the PC 10 accesses the remote UI of the multifunction printer 20, and sets access restriction information indicative of each of PCs which are authorized to access the multifunction printer 20, such as an IP address, a user name, and a password, in the multifunction printer 20 using the remote UI. The setting of the access restriction information using the remote UI may be performed e.g. before copying by the multifunction printer 20. Further, the method or procedure of setting the access restriction information using the remote UI is known, and hence description thereof is omitted.

When the multifunction printer 20 executes copying (step S101 in FIG. 10A), the multifunction printer 20 scans the original by the scanner 207 (step S102 in FIG. 10A), and transmits the scanned image data and access restriction information set therein together with the image data to the server 30 (step S103′ in FIG. 10A). The server 30 receives the access restriction information together with the image data (step S201′ in FIG. 11A), and stores both of them (step S202′ in FIG. 11A).

When the multifunction printer 20 is accessed from the PC 10 (step S106 in FIG. 10A), the multifunction printer 20 determines based on the set access restriction information whether or not the PC 10 is authorized to access the multifunction printer 20 (step S106A in FIG. 10A). In this example, since the PC 10 is an authorized PC, the multifunction printer 20 proceeds to the step S107 to execute processing, such as transmitting of the image information including the URL of the preview image, according to the subsequent steps.

On the other hand, if the access is from an unauthorized PC (NO to the step S106A), the multifunction printer 20 does not permit the access, and returns to the step S106.

When the PC 10 accesses the preview image (step S205 in FIG. 11A), the server 30 determines based on the stored access restriction information whether or not the PC 10 is an authorized PC (step S205A in FIG. 11A). In this example, since the PC 10 is an authorized PC, the server 30 executes the steps S206 et seq. in FIG. 6.

On the other hand, if the access is from an unauthorized PC (NO to the step S205A), the server 30 does not permit the access, and returns to the step S205.

Although in the present embodiment, the access restriction is performed such that only the access from the PC 10 is permitted, the access restriction may be configured such that out of users who use the PC 10, only specific users are authorized to access. In this case, authentication information for authenticating the specific users, such as unique information including user names and passwords, may be set as access restriction information.

Although in the above-described embodiments, the description has been given of the multifunction printer 20 as an example of the image processing apparatus, the image processing apparatus may be a printer, a scanner, a copying machine, or the like. Further, although the description has been given of the server 30 and the PC 10 as an example of the information processing apparatuses implementing the first external apparatus and the second external apparatus, other information processing apparatuses, such as a cellular phone, may be employed.

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-173624, filed Aug. 2, 2010, which is hereby incorporated by reference herein in its entirety.

What is claimed is:

1. An image processing system including an image processing apparatus having a function of reading an original and printing an image obtained by the reading, a first external apparatus including an image processing unit, and a second external apparatus including a display unit, wherein the image processing apparatus, the first external apparatus, and the second external apparatus are connected to each other via a network in a manner capable of communicating with each other,
wherein the first external apparatus comprises:
an image acquisition unit configured to acquire the image read by the image processing apparatus; and
a generation unit configured to generate a preview image which represents an image formed by subjecting the image acquired by said image acquisition unit to image processing by the image processing unit,
wherein said image processing apparatus comprises:
a transmission unit configured to transmit storage location information indicative of a location where the preview image generated by the first external apparatus is stored to the second external apparatus, in response to an access from the second external apparatus, and
wherein the second external apparatus comprises:
an acquisition unit configured to acquire the preview image stored in the first external apparatus, based on the storage location information received from the image processing apparatus; and
a display unit configured to display the preview image acquired by said acquisition unit.

2. The image processing system according to claim 1, wherein the image processing apparatus acquires the storage location information on the preview image from the first external apparatus, and transmits the acquired storage location information to the second external apparatus.

3. The image processing system according to claim 1, wherein the first external apparatus further comprises an image correction unit configured to correct the image based on an image correction instruction from the second external apparatus, and transmits the corrected image to the image processing apparatus in response to a print execution instruction from the second external apparatus.

4. The image processing system according to claim 1, wherein the image processing apparatus further comprises a determination unit configured to determine whether or not the second external apparatus is authorized to access the preview image stored in the first external apparatus, and
wherein when it is determined by said determination unit that the second external apparatus is authorized, said transmission unit transmits the storage location information to the second external apparatus.

5. The image processing system according to claim 1, wherein the image processing apparatus further comprises a determination unit configured to determine whether or not a user who uses the second external apparatus is a specific user, and
wherein when it is determined by said determination unit that the user is a specific user, said transmission unit transmits the storage location information to the second external apparatus.

6. A method of controlling an image processing system including an image processing apparatus having a function of reading an original and printing an image obtained by the reading, a first external apparatus including an image processing unit, and a second external apparatus including a display unit, wherein the image processing apparatus, the first external apparatus, and the second external apparatus are connected to each other via a network in a manner capable of communicating with each other,
wherein the first external apparatus acquires an image read by the image processing apparatus; and
generates a preview image which represents an image formed by subjecting the acquired image to image processing by the image processing unit,
wherein the image processing apparatus transmits storage location information indicative of a location where a preview image generated by the first external apparatus is stored to the second external apparatus, in response to an access from the second external apparatus, and
wherein the second external apparatus acquires the preview image stored in the first external apparatus, based on the storage location information received from the image processing apparatus, and displays the acquired preview image.

7. An image processing apparatus that is capable of communicating with a first external apparatus including an image processing unit, and a second external apparatus including a display unit, comprising:
a reading unit configured to read an original to generate an image;
a first transmission unit configured to transmit the image generated by said reading unit to the first external apparatus;
a reception unit configured to receive storage location information indicative of a location where a preview image is stored which represents an image formed by subjecting the image transmitted by said first transmission unit to image processing by the first external apparatus, from the first external apparatus;
a second transmission unit configured to transmit the storage location information to the second external apparatus in response to an access from the second external apparatus; and
a printing unit configured to execute printing based on the image transmitted from the first external apparatus in response to a print instruction from the second external apparatus.

8. A method of controlling an image processing apparatus that is capable of communicating with a first external apparatus including an image processing unit, and a second external apparatus including a display unit, comprising:
reading an original to generate an image;
transmitting the generated image to the first external apparatus;
receiving storage location information indicative of a location where a preview image is stored which represents an image formed by subjecting the transmitted image to image processing by the first external apparatus, from the first external apparatus;
transmitting the storage location information to the second external apparatus in response to an access from the second external apparatus; and
executing printing based on the image transmitted from the first external apparatus in response to a print instruction from the second external apparatus.

9. A computer-readable storage medium storing a computer-executable program causing a computer to execute a method of controlling an image processing apparatus that is capable of communicating with a first external apparatus including an image processing unit, and a second external apparatus including a display unit,
wherein the method comprises:
reading an original to generate an image;
transmitting the generated image to the first external apparatus;
receiving storage location information indicative of a location where a preview image is stored which represents an image formed by subjecting the transmitted image to image processing by the first external apparatus, from the first external apparatus;
transmitting the storage location information to the second external apparatus in response to an access from the second external apparatus; and
executing printing based on the image transmitted from the first external apparatus in response to a print instruction from the second external apparatus.
